(19) United States
(12) Patent Application Publication
(10) Pub. No.: US 2008/0029359 A1
(43) Pub. Date: Feb. 7, 2008

(54) Torque Converter

(75) Inventors: Yukiyoshi Takada, Osaka (JP); Takeshi Kawamoto, Osaka (JP)

Correspondence Address: GLOBAL IP COUNSELORS, LLP, 1233 20TH STREET, NW, SUITE 700, WASHINGTON, DC, 20036-2680, US

(73) Assignee: Exedy Corporation, Osaka (JP)

(21) Appl. No.: 11/661,661

(22) PCT Filed: Sep. 12, 2005
(86) PCT No.: PCT/JP05/16754

§ 371 Date: Mar. 2, 2007

(30) Foreign Application Priority Data
Sep. 17, 2004 (JP) 2004-271829

(51) Int. Cl. F16D 33/00

(52) U.S. Cl. 192/3.29

(57) ABSTRACT

In a torque converter, by devising a structure of a stator support mechanism, an axial dimension of a radially inner portion of the torque converter and surroundings thereof is reduced. The torque converter (1) includes a front cover (2), an impeller (3), a turbine (4), a stator (5) that regulates fluid flow from the turbine (4) to the impeller (3), and a stator support mechanism (6) that supports the stator (5) to be rotatable only in one direction relative to a fixed shaft. The stator support mechanism (6) includes an annular retainer (61) arranged on an engine side of a stator hub (52), an annular outer race (64) arranged at a radially inner portion of the stator hub (52), an annular first thrust bearing (66) arranged on a transmission side of the stator hub (52), and an annular second thrust bearing (67) arranged on the engine side of the stator hub (52) and at a radially outer portion of the outer race (64).

### TECHNICAL FIELD

The present invention relates to a torque converter, particularly to a torque converter including a stator.

### BACKGROUND ART

A torque converter is a device for transmitting torque from an engine to a transmission by fluid. The torque converter primarily includes a front cover to which torque from the engine is input, an impeller provided in the front cover, a turbine arranged to be opposite to the impeller, a stator for regulating fluid flow from the turbine to the impeller, and a stator support mechanism for supporting the stator.

The stator is arranged between radially inner portions of the impeller and the turbine. The stator includes an annular stator hub arranged at a radially inner portion and a plurality of stator blades arranged at an outer peripheral side of the stator hub. The stator is supported by the stator support mechanism via the stator hub.

The stator support mechanism supports the stator relative to a fixed shaft extending from the transmission side and is provided inside a radially inner periphery of the stator. The stator support mechanism includes a one-way clutch, a retainer, a first thrust bearing, and a second thrust bearing. The one-way clutch supports the stator to be rotatable only in one direction relative to the fixed shaft, and is arranged radially outward of the fixed shaft. The one-way clutch includes an annular outer race arranged inside a radially inner periphery of the stator hub, an annular inner race splined to the radially outer portion of the fixed shaft, and a clutch member arranged between the outer race and the inner race and that allows the outer race and the inner race to rotate relatively only in one direction. The retainer is an annular member arranged on the engine side of the stator hub, and is arranged between the outer race and inner race, and between the first thrust bearing and the second thrust bearing. The first thrust bearing is arranged on the transmission side of the retainer. The second thrust bearing is arranged on the engine side of the stator hub (See, for example, patent document 1).

The foregoing torque converter transmits torque by the following operations. First, the front cover and the impeller are rotated by torque inputted from the engine. When the rotation of the impeller causes the fluid to flow from an outer periphery side of the impeller into an outer periphery side of the turbine by the blades of the impeller and action of the centrifugal force. The fluid that flows into the radially outer portion of the turbine passes through flow passages formed in the turbine with the blades, and returns into the radially inner portion of the impeller through the radially inner portion of the turbine. At this time, since the fluid strikes the blades of the turbine, the turbine rotates in the same direction as the impeller. With this fluid flow, torque inputted to the front cover rotates the turbine. Then, torque is outputted to the output shaft via the turbine.

When a difference of rotation speeds between the impeller and the turbine is significant, the fluid that flows from the radially inner portion of the turbine into the radially inner portion of the impeller flows in a direction to impede a rotation of the impeller. Thus, the one-way clutch prevents the stator from rotating in a direction opposite to the rotational direction of the impeller so that the fluid flows in a direction not to impede the rotation of the impeller. In this case, the fluid impinges front surfaces of stator blades (i.e., surfaces on the same side as the rotational direction of the impeller) to change the flow direction of the fluid flow to the rotational direction of the impeller. As a result, a torque ratio of the torque converter increases.

On the other hand, when a difference of rotation speeds between the impeller and the turbine is reduced, the fluid that flows from the radially inner portion of the turbine to the radially inner portion of the impeller strikes back surfaces of the stator blades (i.e., surfaces on a side opposite to the rotational direction of the impeller). In the foregoing state, the fluid does not prevent the impeller from rotating when the stator is rotatable, and the efficiency of torque transmission increases in the torque converter. In this case, since the stator is rotatable in the rotational direction of the impeller by the one-way clutch, the fluid that contacts the back surface of the stator blade does not impede the rotation of the impeller. As a result, the efficiency of the torque transmission is improved.

As explained above, since the stator regulates the fluid flow in the fluid chamber, the stator receives the load in the axial direction and in the circumferential direction from the fluid via the stator blade. Accordingly, the stator support mechanism supports the stator while receiving various loads applied on the stator.
Patent document 1: Japanese published unexamined application JP10-299858A

### DISCLOSURE OF INVENTION

### Problems to be Solved by the Invention

In a conventional stator support mechanism, however, a diameter of the second thrust bearing provided on the engine side is smaller than a diameter of the first thrust bearing, considering manufacturing costs of the bearing and axial dimension surrounding the stator support mechanism. Namely, the conventional stator is supported by two thrust bearings having different diameters in an axial direction (e.g., See Patent document 1).

The diameter of the second thrust bearing is smaller than the diameter of the first thrust bearing because the second thrust bearing is arranged at the radially inner portion of a plurality of rivets that couple a turbine shell and the turbine hub. Further, this is because the first thrust bearing is arranged at the outer peripheral side of the outer race with the radial position thereof being out of alignment in order to reduce the axial dimension.

Having two different diameters for the thrust bearings cause the following drawbacks when the load in the axial direction is applied to the stator. For example, when the axial load toward the transmission is applied to the turbine, the axial load is transmitted in sequence through the second thrust bearing, the retainer, the outer race, and the stator hub, to the first thrust bearing. At this time, the axial load is transmitted from the second thrust bearing to a radially inner portion of the retainer and is transmitted to the outer race through a radially outer portion of the retainer. Thus, when the strength of the retainer is low and the rigidity of the retainer is not enough, the retainer bends in the axial direction. Upon the deflection of the retainer in the axial direction, a raceway surface of the second thrust bearing that is in contact with the retainer is tilted and the excessive load is applied to the second thrust bearing. Accordingly, the longevity of the second thrust bearing gets shorter. Further, increasing the thickness of the retainer in the axial direction in order to ensure the strength thereof would increase the axial dimension of the stator support mechanism and the surroundings. An increase of the axial dimension of the stator support mechanism and the surroundings thereof increases the size of the radially inner portion of the torque converter in the axial direction and the surroundings thereof, which is not favorable in terms of increased weight and arrangement of the parts.

It is an object of the present invention to shorten the axial dimension at and around the radially inner portion of the torque converter by devising structures of the stator support mechanism.

### Means for Solving the Problems

A torque converter according to a first aspect of the present invention is arranged around a fixed shaft and transmits by fluid torque from an engine to an output shaft extending toward a transmission. The torque converter has a front cover arranged on an engine side and to which torque from the engine is input, an impeller arranged on a transmission side of the front cover to form a fluid chamber together with the front cover and provided with a plurality of blades therein, a turbine arranged on the engine side of the impeller in the fluid chamber to output the torque to the output shaft, a stator arranged between a radially inner portion of the impeller and the turbine to regulate fluid flow from the turbine to the impeller, and a stator support mechanism supporting the stator to be rotatable only in one direction relative to the fixed shaft. The stator includes an annular stator hub arranged at a radially inner portion thereof and the stator support mechanism includes an annular retainer arranged on the engine side of the stator hub, an annular outer race arranged inside the radially inner periphery of the stator hub, an annular first thrust bearing arranged on the transmission side of the stator hub, and an annular second thrust bearing arranged on the engine side of the stator hub and radially outward of the outer race.

With the conventional torque converter, a diameter of the second thrust bearing of the stator support mechanism is shorter than a diameter of the first thrust bearing, that is, a diameter of the outer race. For that reason, when an axial load is applied to the stator, the retainer may deflect in the axial direction. Accordingly, the retainer is required to have a thickness of a certain degree in order to ensure the strength thereof. However, with the torque converter of the present invention, since the second thrust bearing is arranged radially outward of the outer race, a radially outer portion can be supported compared to the conventional torque converter. Namely, although the conventional second thrust bearing supports the retainer in the surroundings of the inner race, the second thrust bearing of the present invention supports the retainer in the surroundings of the stator hub, which is arranged radially outside of the inner race.

Accordingly, since it is not necessary to consider the deflection of the retainer, which is arranged between the second thrust bearing and the stator hub in the axial direction, a thickness of the retainer can be reduced, and thus an axial dimension of a radially inner portion of the torque converter and surroundings thereof can be reduced. Further, since the retainer does not deflect in the axial direction, a raceway of the second thrust bearing is not tilted, which prevents the second thrust bearing from shortening the longevity thereof.

A torque converter according to a second aspect of the present invention is the torque converter of the first aspect, wherein the second thrust bearing is arranged so that a central position relative to radially inner and outer edges thereof is arranged radially outward of a radially outer edge of the outer race.

With this torque converter, since the central position relative to radially inner and outer edges of the second thrust bearing is arranged at a radially outward of an radially outer edge of the outer race, a center to which the axial load applied is arranged closer to the stator hub compared to the conventional construction, and thus the surroundings of the stator hub can be supported compared to the conventional construction. Accordingly, since it is not necessary to consider the deflection of the retainer, which is arranged between the second thrust bearing and the stator hub in an axial direction, a thickness of the retainer can be reduced, and thus an axial dimension of a radially inner portion of the torque converter and surroundings thereof can be reduced. Further, since the retainer does not deflect in the axial direction, a raceway of the second thrust bearing is not tilted, and this prevents the second thrust bearing from shortening the longevity thereof.

A torque converter according to a fourth aspect of the present invention is the torque converter of the first aspect, wherein the second thrust bearing is arranged so that a radially inner edge thereof is arranged radially outward of a radially outer edge of the outer race.

With the torque converter of the present invention, since a radially inner edge of the second thrust bearing is arranged radially outward of a radially outer edge of the outer race, the surroundings of the stator hub, which is radially outward compared to the conventional construction, can be supported. Accordingly, since it is not necessary to consider the deflection of the retainer, which is arranged between the second thrust bearing and the stator hub in an axial direction, a thickness of the retainer can be reduced, and thus an axial dimension of a radially inner portion of the torque converter and surroundings thereof can be reduced. Further, because the retainer does not deflect in the axial direction, a raceway of the second thrust bearing is not tilted, and this prevents the second thrust bearing from shortening the longevity thereof.

A torque converter according to a fourth aspect of the present invention is arranged around a fixed shaft and transmits by fluid torque from an engine to an output shaft extending toward a transmission. The torque converter has a front cover arranged on an engine side and to which torque from the engine is input, an impeller arranged on a transmission side of the front cover to form a fluid chamber together with the front cover and provided with a plurality of blades therein, a turbine arranged on the engine side of the impeller in the fluid chamber to output torque to the output shaft, a stator arranged between radially inner portions of the impeller and the turbine to regulate fluid flow from the turbine to the impeller, and a stator support mechanism supporting the stator to be rotatable only in one direction relative to the fixed shaft. The turbine includes a turbine shell provided with a plurality of blades facing the impeller, a turbine hub arranged inside a radially inner periphery of the turbine shell to couple the output shaft with the turbine shell, and a plurality of fixing members arranged in a circumferential direction to couple the turbine shell with the turbine hub non-rotatably, the stator includes an annular stator hub arranged at a radially inner portion thereof. The stator support mechanism includes an annular retainer arranged on the engine side of the stator hub, an annular first thrust bearing arranged on the transmission side of the stator hub, and an annular second thrust bearing arranged on the engine side of the stator hub and radially outward of the plurality of the fixing members.

With this torque converter, since the second thrust bearing is arranged radially outward of the fixing members of the turbine, the second thrust bearing can support the surroundings of the stator hub, which is further radially outward, while reducing the axial dimension of the stator support mechanism and surroundings thereof. Accordingly, since it is not necessary to consider the deflection of the retainer in an axial direction, a thickness of the retainer can be reduced, and thus an axial dimension of a radially inner portion of the torque converter and surroundings thereof can be reduced. Further, since the retainer does not deflect in the axial direction, a raceway of the second thrust bearing is not tilted, and this prevents the second thrust bearing from shortening the longevity thereof.

A torque converter according to a fifth aspect of the present invention is the torque converter of the fourth aspect, wherein the second thrust bearing is arranged overlapping with the fixing members in an axial direction.

With this torque converter, since the axial position of the second thrust bearing is overlapped with the fixing members an axial dimension of the radially inner portion of the torque converter and surroundings thereof can be further reduced.

A torque converter according to a sixth aspect of the present invention is arranged around a fixed shaft and transmits by fluid torque from an engine to an output shaft extending toward a transmission. The torque converter has a front cover arranged on an engine side and transmits the torque from the engine, an impeller arranged on a transmission side of the front cover to form a fluid chamber together with the front cover and provided with a plurality of blades therein, a turbine arranged on the engine side of the impeller in the fluid chamber to output torque to the output shaft, a stator arranged between radially inner portions of the impeller and the turbine to regulate fluid flow from the turbine to the impeller, and a stator support mechanism supporting the stator to be rotatable only in one direction relative to the fixed shaft. The stator includes an annular stator hub arranged at a radially inner portion thereof. The stator support mechanism includes an annular retainer arranged on the engine side of the stator hub, an annular first thrust bearing arranged on the transmission side of the stator hub, and an annular second thrust bearing arranged on the engine side of the stator hub and arranged at a substantially identical radial position relative to the first thrust bearing.

With this torque converter, since the second thrust bearing is arranged at a substantially identical radial position relative to the first thrust bearing, the positions that support the axial load applied to the stator hub come to be substantially identical, and a supporting state of the stator hub is stabilized. Accordingly, with this torque converter, since it is not necessary to consider the axial deflection of the retainer that is arranged between the second thrust bearing and the stator hub, a thickness of the retainer can be reduced, and thus an axial dimension of a radially inner portion of the torque converter and surroundings thereof can be reduced. Further, since the retainer does not deflect in the axial direction, a raceway of the second thrust bearing is not tilted and this prevents the second thrust bearing from shortening the longevity thereof.

A torque converter according to a seventh aspect of the present invention is the torque converter of any of the first to sixth aspects, wherein the retainer is arranged between the stator hub and the second thrust bearing in an axial direction.

With this torque converter, since the retainer is arranged between the stator hub and the second thrust bearing in the axial direction, only the axial compressive load acts on the retainer. Accordingly, with this torque converter, a thickness of the retainer can be reduced, and thus an axial dimension of a radially inner portion of the torque converter and surroundings thereof can be reduced. Further, since the retainer does not deflect in the axial direction, a raceway of the second thrust bearing is not tilted and this prevents the second thrust bearing from shortening the longevity thereof.

A torque converter according to a eighth aspect of the present invention is the torque converter of any of the first to seventh aspects, wherein the retainer includes an annular projecting portion that annularly projects toward the engine and engages with the second thrust bearing in a radial direction.

With this torque converter, since the retainer includes the annular projecting portion that engages with the second thrust bearing in a radial direction, the radial position of the second thrust bearing relative to the retainer is stabilized.

A torque converter according to a ninth aspect of the present invention is the torque converter of the eighth aspect, wherein the second thrust bearing is fitted in a radially inner periphery of the annular projecting portion.

With this torque converter, since the second thrust bearing is fitted in the radially inner peripheral of the annular projecting portion, the position of the second thrust bearing relative to the retainer in radial direction is further stabilized.

A torque converter according to a tenth aspect of the present invention is arranged around a fixed shaft and transmits by fluid torque from an engine to an output shaft extending toward a transmission by fluid. The torque converter has a front cover arranged on an engine side and to which torque from the engine is input, an impeller arranged on a transmission side of the front cover to form a fluid chamber together with the front cover and provided with a plurality of blades therein, a turbine arranged on the engine side of the impeller in the fluid chamber to output the torque to the output shaft, a stator arranged between radially inner portions of the impeller and the turbine to regulate fluid flow from the turbine to the impeller, and a stator support mechanism supporting the stator to be rotatable only in one direction relative to the fixed shaft. The stator includes an annular stator hub arranged at a radially inner portion thereof. The stator support mechanism includes an annular retainer arranged on the engine side of the stator hub and an annular outer race arranged inside a radially inner periphery of the stator hub. A radially outer portion of the retainer is in contact with the stator hub in an axial direction.

With this torque converter, since the radially outer portion of the retainer is in contact with the stator hub in an axial direction, the second thrust bearing can be arranged in the surroundings of the stator hub. Accordingly, with the torque converter of the present invention, since it is not necessary to consider the deflection of the retainer in the axial direction, a thickness of the retainer can be reduced, and thus an axial dimension of a radially inner portion of the torque converter and surroundings thereof can be reduced. Further, since the retainer does not deflect in the axial direction, a raceway of the second thrust bearing is not tilted and this prevents the second thrust bearing from shortening the longevity thereof. Further, with this torque converter, the axial position of the retainer relative to the stator hub can be stabilized.

A torque converter according to an eleventh aspect of the present invention is the torque converter of any of the first to tenth aspects, wherein the stator hub includes an annular portion that annularly projects toward the engine and engages with the retainer in a radial direction.

With this torque converter, since the stator hub includes an annular portion which engages with the retainer in a radial direction, the radial position of the retainer relative to the stator hub can be stabilized.

A torque converter according to a twelfth aspect of the present invention is the torque converter of the eleventh aspect, wherein the retainer is fitted in a radially inner periphery of the annular portion to be non-rotatable relative to the stator hub.

According to the torque converter of the present invention, since the retainer is fitted in a radially inner periphery of the annular portion to be non-rotatable relative to the stator hub, the radial position of the retainer relative to the stator hub can be further stabilized. Further, with this torque converter, the axial position of the retainer relative to the stator hub can be further stabilized.

A torque converter according to a thirteenth aspect of the present invention is arranged around a fixed shaft and transmits by fluid torque from an engine to an output shaft extending toward a transmission. The torque converter has a front cover arranged on an engine side and transmits the torque from the engine, an impeller arranged on a transmission side of the front cover to form a fluid chamber together with the front cover and provided with a plurality of blades therein, a turbine arranged on the engine side of the impeller in the fluid chamber to output the torque to the output shaft, a stator arranged between radially inner portions of the impeller and the turbine to regulate fluid flow from the turbine to the impeller, and a stator support mechanism supporting the stator relative to the fixed shaft. The stator includes an annular stator hub arranged at a radially inner portion thereof. The stator hub includes a cylindrical portion to which the stator is fixed and cylindrically extends in an axial direction and a disc portion which extends from the cylindrical portion radially inward. An axial load applied to the stator hub is supported by axial ends of the cylindrical portion.

According to the torque converter of the present invention, since the load applied to the stator hub in the axial direction is supported by the axial ends of the cylindrical portion, the supporting state of the stator hub can be stabilized. Further, with the torque converter of the present invention, since the axial load can be supported by the cylindrical portion and the surroundings thereof, it is not necessary to consider the deflection of the retainer in the axial direction. Accordingly, a thickness of the retainer can be reduced, and thus an axial dimension of a radially inner portion of the torque converter and surroundings thereof can be reduced. Further, since the retainer does not deflect in the axial direction, a raceway of the second thrust bearing is not tilted and this prevents the second thrust bearing from shortening the longevity thereof.

A torque converter according to a fourteenth aspect of the present invention is the torque converter of the thirteenth aspect, wherein the stator support mechanism includes an annular second thrust bearing that is arranged on the engine side of the stator hub and a retainer arranged between the stator hub and the second thrust bearing in an axial direction.

With this torque converter, since the retainer is arranged between the stator hub and the second thrust bearing in the axial direction, only the axial compressive load acts on the retainer. Accordingly, with this torque converter, a thickness of the retainer can be reduced, and thus an axial dimension of a radially inner portion of the torque converter and surroundings thereof can be reduced. Further, since the retainer does not deflect in the axial direction, a raceway of the second thrust bearing is not tilted and this prevents the second thrust bearing from shortening the longevity thereof.

A torque converter according to a fifteenth aspect of the present invention is the torque converter of the fourteenth aspect, wherein the retainer includes an annular projecting portion which annularly projects toward the engine and engages with the second thrust bearing in a radial direction.

With this torque converter, since the retainer includes an annular projecting portion that engages with the second thrust bearing in a radial direction, the radial position of the second thrust bearing relative to the retainer is stabilized.

A torque converter according to a sixteenth aspect of the present invention is the torque converter of the fifteenth aspect, wherein the second thrust bearing is fitted in a radially inner periphery of the annular projecting portion.

With this torque converter, since the second thrust bearing is fitted in the radially inner periphery of the annular projecting portion, the radial position of the second thrust bearing relative to the retainer is further stabilized.

A torque converter according to a seventeenth aspect of the present invention is the torque converter of any of the fourteenth to sixteenth aspects, wherein the stator hub includes an annular portion that annularly projects toward the engine and engages with the retainer in a radial direction.

With this torque converter, since the stator hub includes an annular portion that engages with the retainer in the radial direction, the radial position of the retainer relative to the stator hub can be stabilized.

A torque converter according to an eighteenth aspect of the present invention is the torque converter of the seventeenth aspect, wherein the retainer is fitted in a radially inner periphery of the annular portion to be non-rotatable relative to the stator hub.

With this torque converter of the present invention, since the retainer is fitted in the radially inner periphery of the annular portion to be non-rotatable relative to the stator hub, the radial position of the retainer relative to the stator hub can be further stabilized. Further, with this torque converter, the axial position of the retainer relative to the stator hub can be further stabilized.

### Effects of the Invention

With the torque converter according to the present invention, an axial dimension of the radially inner portion of the torque converter and surroundings thereof can be reduced.

### BRIEF DESCRIPTION OF DRAWINGS

FIG. 1 is a longitudinal cross-sectional view of a torque converter 1 according to an embodiment of the present invention.

FIG. 2 is a magnified view of a stator support mechanism 6 and surroundings thereof.

### EXPLANATIONS FOR REFERENCE NUMBER

1 torque converter
2 front cover
3 impeller
4 turbine
5 stator
6 stator support mechanism
7 lock-up clutch
13 turbine hub
14 rivet (fixing member)
15 flange
51 stator blade
52 stator hub
53 stator hub main body (cylindrical portion)
54 disc portion
55 first annular portion
56 second annular portion (annular portion)
61 retainer
62 one-way clutch
63 clutch member
64 outer race
65 inner race
66 first thrust bearing
67 second thrust bearing
68 annular projecting portion

### MODE FOR CARRYING OUT THE INVENTION

One embodiment of the present invention will be explained with reference to the illustrations of the drawing figures as follows.

### 1. Structure of the Torque Converter

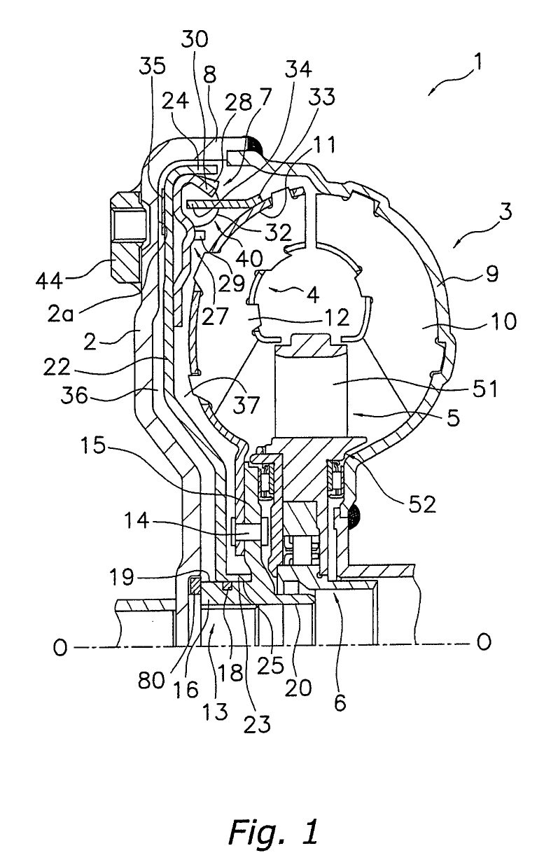

FIG. 1 shows a longitudinal cross-sectional view of a torque converter 1 according to an embodiment of the present invention. The line O-O in FIG. 1 shows a rotational axis of the torque converter 1.

As shown in FIG. 1, the torque converter 1 forms a fluid chamber with a front cover 2 and an impeller shell 9, which is fixed on a radially outer projection 8 of the front cover 2. The front cover 2 is attachable to and detachable from a crankshaft of an engine by components and inputs torque from engine thereto. A plurality of impeller blades 10 are fixed on the inside of the impeller shell 9, described later. An impeller 3 is made of the impeller shell 9 and the impeller blades 10. A turbine 4 is arranged in the fluid chamber at a position facing the impeller 3. The turbine 4 includes a turbine shell 11 and a plurality of turbine blades 12 fixed on the turbine shell 11. A radially inner portion of the turbine shell 11 is fixed on a flange 15 of a turbine hub 13 by rivets 14. The turbine hub 13 is formed with a spline 20, the spline 20 which is configured to engage with a main driveshaft (i.e., an output shaft) of a transmission, at a radially inner portion thereof. A stator 5 is arranged between a radially inner portion of the impeller 3 and a radially inner portion of the turbine 4. The stator 5, which regulates a direction of the fluid returning from the turbine 4 to the impeller 3, is supported by a fixed shaft via a stator support mechanism 6. The fixed shaft is a cylindrical member that extends from the transmission side. The main drive shaft penetrates through the fixed shaft. The stator 5 includes a stator hub 52, which is supported by the stator support mechanism 6, and a plurality of stator blades 51, which is arranged radially outward of the stator hub 52.

### 2. Structure of the Lock-Up Clutch

A lockup clutch 7 is arranged in a space between the front cover 2 and the turbine 4 mechanically connecting the front cover 2 and the turbine 4. The lockup clutch 7 includes a piston 22, and an elastic coupling mechanism 40 elastically coupling the piston 2 to the turbine 4.

The piston 22, which is shaped in an approximately disc form, is arranged to divide the space between the front cover 2 and the turbine shell 11 into a first hydraulic chamber 36 at the front cover 2 side and a second hydraulic chamber 37 at the turbine 4 side. The piston 22 is made from a thin sheet metal. The piston 22 includes a radially inner cylindrical portion 23 that extends toward the transmission. The radially inner cylindrical portion 23 is supported by an outer peripheral surface 19 of a cylindrical portion 16 of the flange 15 of the turbine hub 13 to be relatively movable in an axial direction and in a circumferential direction. Namely, a radially inner surface 25 of the radially inner cylindrical portion 23 is in contact with the outer peripheral surface 19 of the cylindrical portion 16. An annular groove is formed on the outer peripheral surface 19 of the cylindrical portion 16 at an intermediate position in a radial direction. A seal ring 18 is provided in the annular groove, and the seal ring 18 is in contact with the radially inner surface 25 of the radially inner cylindrical portion 23. Thus, the seal ring 18 seals radially inner portions of the first hydraulic chamber 36 and the second hydraulic chamber 37.

A radially outer cylindrical portion 24 which extends toward the transmission is formed at a radially outer portion of the piston 22. An annular friction facing 35 is provided on an engine side of a radially outer portion of the piston 22. The friction facing 35 faces an annular plain friction surface 2a, which is formed at a radially outer portion of an internal surface of the front cover 2. An engagement of the friction facing 35 and the friction surface 2a of the front cover 2 seals radially outer portions of the first hydraulic chamber 36 and the second hydraulic chamber 37.

The elastic coupling mechanism 40 is arranged between the piston 22 and the turbine 4, more particularly, between a radially outer portion of the piston 22 and a radially outer portion of the turbine shell 11. The elastic coupling mechanism 40 includes a retaining plate 27 serving as a driving side member, a driven plate 33 serving as a driven side member, and a plurality of coil springs 32 arranged between the retaining plate 27 and the driven plate 33. The retaining plate 27 is an annular plate member that is arranged on a transmission side of a radially outer portion of the piston 22, that is, inside a radially inner periphery of the radially outer cylindrical portion 24. A radially inner portion of the retaining plate 27 is fixed to the piston 22 by a plurality of rivets. The retaining plate 27 is engaged with both circumferential sides of a coil spring 32 to transmit the torque while supporting the coil spring 32. The retaining plate 27 includes supporting portions 28 and 29, which respectively support a radially outer portion and a radially inner portion of the plurality of coil springs 32 arranged in the circumferential direction. The supporting portion 29, which is arranged radially inward, is formed by curving and lifting a disc shaped portion of the retaining plate 27. Further, the retaining plate 27 includes an engagement portion 30, which supports the both circumferential sides of each of the coil springs 32. The driven plate 33 is an annular plate member that is fixed on a rear surface of the turbine shell 11 at the radially outer portion thereof. The driven plate 33 includes a plurality of pawl portions 34 extending toward the engine and arranged in the circumferential direction. The pawl portion 34 is engaged with both circumferential ends of each of the coil springs 32. Accordingly, the torque from the retaining plate 27 is transmitted to the driven plate 33 via the coil spring 32.

### 3. Structure of the Stator Support Mechanism and its Surroundings

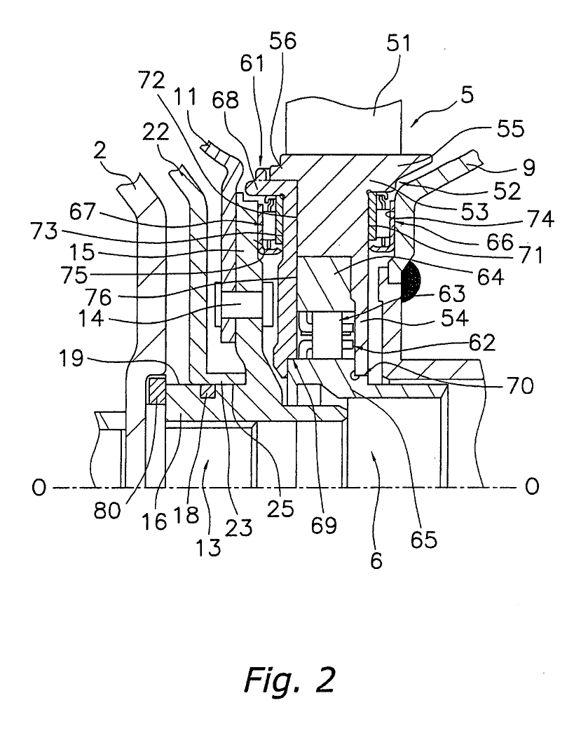

FIG. 2 shows a magnified view of the stator support mechanism 6 and the surroundings thereof. The stator support mechanism 6 includes a retainer 61, a one-way clutch 62, a first thrust bearing 66, and a second thrust bearing 67.

The retainer 61 is an annular member that is provided on the engine side of the stator hub 52. The stator hub 52 includes an approximately cylindrical stator hub main body 53 to which the plurality of stator blades 51 is provided on the radially outer portion thereof and a disc portion 54 that extends radially inward from the stator hub main body 53. A second annular portion 56 that annularly projects toward the engine is formed on the engine side of a radially outer portion of the stator hub main body 53. The retainer 61 is fitted in a radially inner periphery of the second annular portion 56 while an outer surface thereof is in contact with a second thrust surface 72 to be relatively non-rotatable. Thus, the retainer 61 is stably arranged relative to the stator hub 52 in a radial direction and an axial direction.

The one-way clutch 62 includes an annular outer race 64 that is arranged inside a radially inner periphery of the stator hub 52, an annular inner race 65 that is splined to a radially outer portion of a fixed shaft, and a clutch member 63 that is provided between the outer race 64 and the inner race 65 so that the outer race 64 and the inner race 65 are relatively rotatable only in one direction.

The first thrust bearing 66 is provided between the stator hub 52 and the impeller shell 9. A first annular portion 55 that annularly projects toward the transmission is formed on the stator hub main body 53 on the transmission side of a radially outer portion. The first thrust bearing 66 is fitted in a radially inner periphery of the first annular portion 55 while being in contact with a first thrust surface 71. Thus, the position of the first thrust bearing 66 in the radial direction and in the axial direction relative to the stator hub 52 is stabilized. Further, the first thrust bearing 66 is in contact with a fourth thrust surface 74 of the impeller shell 9. Accordingly, the axial load applied to the stator hub 52 toward the transmission is supported by the impeller shell 9 via the first thrust bearing 66.

The second thrust bearing 67 is provided between the retainer 61 and the flange 15 of the turbine hub 13. An annular projecting portion 68 that annularly projects toward the engine is formed on the retainer 61 at a radially outer portion on the engine side. The second thrust bearing 67 is fitted in a radially inner peripheral of the annular projecting portion 68 while being in contact with a third thrust surface 73. Thus, the second thrust bearing 67 is stably arranged in the radial direction and in the axial direction relative to the retainer 61 and the stator hub 52. The second thrust bearing 67 is in contact with a fifth thrust surface 75 of the flange 15 of the turbine hub 13 on the engine side. An annular thrust washer 80 that supports the turbine hub 13 in the axial direction is provided between an end portion of the turbine hub 13 closer to the engine and the front cover 2. Thus, the axial load applied to the stator hub 52 toward the engine is supported by the front cover 2 via the retainer 61, the second thrust bearing 67, the turbine hub 13, and the thrust washer 80.

The outer race 64 is sandwiched between the retainer 61 and the disc portion 54 in the axial direction because the retainer 61 is fitted in the second annular portion 56 of the stator hub main body 53. The retainer 61 is formed with a first stepped portion 69 at a radially inner portion thereof. The retainer 61 and a radially outer edge of the inner race 65 engage via the first stepped portion 69 to be relatively rotatable and immovable in the axial direction toward the transmission. The inner race 65 is formed with a second stepped portion 70 at a portion engaging with the disc portion 54. The inner race 65 and a radially inner edge of the disc portion 54 engage via the second stepped portion 70 to be relatively rotatable and immovable in the axial direction toward the engine.

As explained above, the stator 5, the retainer 61, and the outer race 64 serve as an integral member because the retainer 61 is fitted in the stator hub 52. The integrally functioning member including the stator 5, the retainer 61, and the outer race 64 is supported by the stator support mechanism 6 so as to be relatively rotatable and immovable in the axial direction relative to the impeller shell 9, the front cover 2, and the turbine hub 13.

Positioning of the second thrust bearing 67 has a feature when compared to the conventional second thrust bearing. Particularly, the second thrust bearing 67 is arranged radially outward of the outer race 64. More particularly, a radially inner edge of the second thrust bearing 67 is arranged radially outward of a radially outer edge of the outer race 64. Namely, the second thrust bearing 67 is arranged on the engine side relative to the stator hub main body 53 of the stator hub 52. Considering the axial dimension, the second thrust bearing 67 is arranged radially outward relative to the rivet 14 of the turbine hub 13. Thus, the positioning of the first thrust bearing 66 and the second thrust bearing 67 in the radial direction can be substantially identical. Accordingly, the axial load applied to the stator hub 52 can be supported by the both axial ends of the stator hub main body 53.

With the construction of the conventional second thrust bearing, since the second thrust bearing is provided in the surroundings of the inner race and radially inward relative to the rivet of the turbine hub, a load-point affecting the retainer is out of alignment in a radial direction. As a result, since the retainer is deflected in the axial direction, the raceway of the second thrust bearing is tilted and thus the longevity of the second thrust bearing is shortened. With the second thrust bearing according to the present invention, however, by arranging the second thrust bearing 67 radially outward of the outer race 64, a radial position of the second thrust bearing 67 can be substantially identical to a radial position of the first thrust bearing 66. In this case, since only the axial compressive load acts on the retainer 61, the retainer 61 is not deflected in the axial direction. As a result, the raceway of the second thrust bearing 67 is not tilted, which prevents the second thrust bearing 67 from shortening the longevity thereof. Further, since the axial load applied to the stator hub 52 can be supported by both axial ends of the stator hub main body 53, the supporting state of the stator hub 52 is further stabilized.

### 4. Operation

An operation of the torque converter 1 will be explained as follows. The rotation of the front cover 2 by torque from the engine leads the impeller 3 to rotate along with the front cover 2. The rotation of the impeller 3 causes the fluid to flow from the radially outer portion of the impeller 3 to the radially outer portion of the turbine 4 by the impeller blades 10 and action of the centrifugal force. The fluid that flows to the radially outer portion of the turbine 4 returns from the radially inner portion of the turbine 4 to the radially inner portion of the impeller 3 through flow passages which are formed by the turbine blades 12 in the turbine 4. At this time, because the fluid strikes vanes of the turbine 4, the turbine 4 rotates in the same direction with the impeller 3. With the fluid flow explained above, torque transmitted to the front cover 2 rotates the turbine 4. Accordingly, torque is outputted to a main driveshaft via the turbine 4.

A differential of the rotating speeds between the impeller 3 and the turbine 4 may cause the torque transmitting efficiency to decline. Therefore, the stator 5 regulates the fluid flow when the fluid returns from the turbine 4 to the impeller 3. Particularly, when the differential of the rotating speeds between the impeller 3 and the turbine 4 is significant, the fluid that flows from the radially inner portion of the turbine 4 to the radially inner portion of the impeller 3 flows in a direction to impede the rotation of the impeller 3. Thus, the fluid impinges on a front surface of the stator blade 51, that is, a surface on a same side as the rotational direction of the impeller 3, results in changing the flow direction to the rotational direction of the impeller 3. At this time, fixing the stator 5 by the one-way clutch 62 provides improving torque ratio of the torque converter 1.

On the other hand, when the differential of the rotating speeds between the impeller 3 and the turbine 4 is reduced, the fluid that flows from the radially inner portion of the turbine 4 to the radially inner portion of the impeller 3 strikes against a back surface of the stator blade 51, that is, a surface on an opposite side to the rotational direction of the impeller 3. In this case, since the one-way clutch 62 enables the stator 5 to rotate, the fluid that strikes against the back surface of the stator blade 51 does not flow in a direction to impede the rotation of the impeller 3. This provides an improvement in the torque transmitting efficiency.

Accordingly, during the operation of the torque converter 1, the stator 5 selectively rotates or stops receiving the reaction force of the fluid in the radial direction and the axial direction. Thus, it is necessary for the stator hub 52 and the retainer 61 of the stator support mechanism 6 to receive the axial load and the axial direction. Further, the axial load may affect the turbine 4. When the axial load is applied to the turbine 4 toward the transmission, the axial load is transmitted in sequence through the flange 15, the second thrust bearing 67, the retainer 61 and the stator hub 52, to the first thrust bearing 66. At this time, since the second thrust bearing 67 is arranged in the surroundings of the stator hub main body 53 of the stator hub 52, the retainer 61 is compressed between the second thrust bearing 67 and the stator hub 52 by the axial load, but is not deflected in the axial direction. Accordingly, since the raceway of the second thrust bearing 67 is not tilted, the second thrust bearing 67 is prevented from having a short lifespan. In addition, since the retainer 61 is not deflected in the axial direction even if the thickness of the retainer 61 is reduced in the axial direction, the thickness of the retainer 61 can be reduced. Thus the axial dimension of the stator support mechanism 6 and the surroundings thereof can be reduced, and the axial dimension of the torque converter 1 and the surroundings of the radially inner portion thereof can be reduced.

### 5. Effect

Effects of the torque converter 1 according to the present invention will be described as follows.

With the torque converter 1, the second thrust bearing 67 is provided radially outward of the outer race 64. With the torque converter 1, the second thrust bearing 67 is provided on the radailly outer side relative to the rivets 14 of the turbine hub 13. Further, since the outer peripheral portion of the retainer 61 is in contact with the stator hub 52 in the torque converter 1, the second thrust bearing 67 can be arranged in the surroundings of the stator hub 52. Further, with the torque converter 1, the radial position of the second thrust bearing 67 is substantially identical to the radial position of the first thrust bearing 66, and the axial load applied to the stator hub 52 is supported by both axial ends of the stator hub 53. With the foregoing construction, since radially outer portions can be supported with regard to the stator compared to the conventional construction, and thus because it is not necessary to consider that the retainer 61 arranged between the second thrust bearing 67 and the stator hub 52 deflects in the axial deflection, the thickness of the retainer 61 can be reduced, and the axial dimension of the radially inner portion of the torque converter 1 and the surroundings thereof can be reduced. Further, since the retainer 61 does not deflect in the axial direction, the raceway of the second thrust bearing 67 is not tilted, and thus the shortening of the longevity of the second thrust bearing can be prevented.

According to the torque converter 1, since the retainer 61 is arranged between the stator hub 52 and the second thrust bearing 67 in the axial direction, the compressive load only in the axial direction is applied to the retainer 61. Accordingly, with the torque converter 1, the thickness of the retainer 61 can be reduced, and the axial dimension of the internal peripheral portion of the torque converter 1 and the surroundings thereof can be reduced. Further, since the retainer 61 does not deflect in the axial direction, the raceway of the second thrust bearing 67 does not tilt and this prevents the second thrust bearing from having a short lifespan.

With the torque converter 1, since the retainer 61 includes the annular projecting portion 68 that engages with the second thrust bearing 67 in the radial direction and the second thrust bearing 67 is fitted in the inner periphery of the annular projecting portion 68, the radial position of the second thrust bearing 67 relative to the retainer 61 is stabilized.

With the torque converter 1, since the stator hub 52 includes the second annular portion 56 that is engaged with the retainer 61 in the radial direction and the retainer 61 is fitted in the inner periphery of the second annular portion 56 so that the retainer 61 is not relatively rotatable, the positioning of the retainer 61 in the radial direction and the in the axial direction relative to the stator hub 52 can be stabilized.

According to the torque converter 1 explained above, the axial dimension of the radially inner portion of the torque converter 1 and the surroundings thereof can be reduced.

### 6. Other Embodiments

The present invention is not limited to the foregoing embodiment, and variations and changes may be made without departing from the scope of the invention. Other embodiments will be described as follows.

(1) Arrangement of the Second Thrust Bearing

Although the second thrust bearing 67 is arranged radially outward of the outer race 64 and radially outward relative to the rivets 14 in the foregoing embodiment so that the positioning of the second thrust bearing 67 in the radial direction is substantially identical to the radial position of the first thrust bearing, there is no problem with the second thrust bearing 67 being arranged radially inward compared to the foregoing embodiment as long as it is within a range such that the retainer 61 does not deflect in the axial direction. For example, the central position of the radially inner and outer edges of the second thrust bearing 67 may be arranged radially outward of the radially outer edge of the outer race 64 or in the surroundings thereof.

(2) Outer Race

Another embodiment regarding an outer race will be described as follows. Although the foregoing embodiment is described with the assumption that the retainer 61 is mainly in contact with the second thrust surface 72 of the stator hub 52 in the axial direction, the retainer 61 may be in contact with a sixth thrust surface 76 of the outer race 64 in the axial direction. Alternatively, the retainer 61 may be evenly in contact with the second thrust surface 72 and the sixth thrust surface 76.

### INDUSTRIAL APPLICABILITY

Since the axial dimension of the radially inner portion of the torque converter and the surroundings thereof can be reduced, the present invention is applicable to a torque converter, particularly to a torque converter including a stator.

1. A torque converter arranged around a fixed shaft and transmitting torque from an engine to an output shaft extending toward a transmission by fluid, comprising:
a front cover being arranged on an engine side and configured to receive torque from the engine;
an impeller being arranged on a transmission side of the front cover to form a fluid chamber together with the front cover, and having a plurality of blades therein;
a turbine being arranged on the engine side of the impeller in the fluid chamber to output torque to the output shaft;
a stator being arranged between radially inner portions of the impeller and the turbine to regulate fluid flow from the turbine to the impeller; and
a stator support mechanism supporting the stator to be rotatable only in one direction relative to the fixed shaft, the stator having an annular stator hub arranged at a radially inner portion thereof, the stator support mechanism having
an annular retainer being arranged on the engine side of the stator hub,
an annular outer race being arranged inside the radially inner periphery of the stator hub,
an annular first thrust bearing being arranged on the transmission side of the stator hub, and
an annular second thrust bearing being arranged on the engine side of the stator hub and radially outward relative to the outer race.

2. The torque converter according to claim 1, wherein the second thrust bearing is arranged so that a central position relative to radially inner and outer edges thereof is arranged radially outward of an radially outer edge of the outer race.

3. The torque converter according to claim 1, wherein the second thrust bearing is arranged so that a radially inner edge thereof is arranged radially outward of a radially outer edge of the outer race.

4. A torque converter arranged around a fixed shaft and transmitting torque from an engine to an output shaft extending toward a transmission by fluid, comprising:
a front cover being arranged on an engine side and configured to receive torque from the engine;
an impeller being arranged on a transmission side of the front cover to form a fluid chamber together with the front cover, and having a plurality of blades therein;
a turbine being arranged on the engine side of the impeller in the fluid chamber to output torque to the output shaft;
a stator being arranged between radially inner portions of the impeller and the turbine to regulate fluid flow from the turbine to the impeller; and
a stator support mechanism supporting the stator to be rotatable only in one direction relative to the fixed shaft,
the turbine having
a turbine shell having a plurality of blades facing the impeller,
a turbine hub being arranged inside a radially inner periphery of the turbine shell to couple the output shaft with the turbine shell, and
a plurality of fixing members being arranged in a circumferential direction to couple non-rotatably the turbine shell with the turbine hub,
the stator having an annular stator hub being arranged at a radially inner portion thereof, and
the stator support mechanism having
an annular retainer being arranged on the engine side of the stator hub,
an annular first thrust bearing being arranged on the transmission side of the stator hub, and
an annular second thrust bearing being arranged on the engine side of the stator hub and radially outward of the plurality of the fixing members.

5. The torque converter according to claim 4, wherein the second thrust bearing is arranged overlapping with the fixing members in an axial direction.

6. A torque converter arranged around a fixed shaft and transmitting torque from an engine to an output shaft extending toward a transmission by fluid, comprising:
a front cover being arranged on an engine side and configured to receive torque from the engine;
an impeller being arranged on a transmission side of the front cover to form a fluid chamber together with the front cover and having a plurality of blades therein;
a turbine being arranged on the engine side of the impeller in the fluid chamber to output torque to the output shaft;
a stator being arranged between radially inner portions of the impeller and the turbine to regulate fluid flow from the turbine to the impeller; and
a stator support mechanism supporting the stator to be rotatable only in one direction relative to the fixed shaft,
the stator having an annular stator hub being arranged at a radially inner portion thereof, and
the stator support mechanism having
an annular retainer being arranged on the engine side of the stator hub,
an annular first thrust bearing being arranged on the transmission side of the stator hub, and
an annular second thrust bearing being arranged on the engine side of the stator hub and arranged at a substantially identical radial position to the first thrust bearing.

7. The torque converter according to claim 6, wherein the retainer is arranged between the stator hub and the second thrust bearing in an axial direction.

8. The torque converter according to claim 7, wherein the retainer includes an annular projecting portion that annularly projects toward the engine and engages with the second thrust bearing in a radial direction.

9. The torque converter according to claim 8, wherein the second thrust bearing is fitted in a radially inner peripheral of the annular projecting portion.

10. A torque converter arranged around a fixed shaft and transmitting torque from an engine to an output shaft extending toward a transmission by fluid, comprising:
a front cover being arranged on an engine side and configured to receive torque from the engine;
an impeller being arranged on a transmission side of the front cover to form a fluid chamber together with the front cover and having a plurality of blades therein;
a turbine being arranged on the engine side of the impeller in the fluid chamber to output torque to the output shaft;
a stator being arranged between radially inner portions of the impeller and the turbine to regulate fluid flow from the turbine to the impeller; and
a stator support mechanism supporting the stator to be rotatable only in one direction relative to the fixed shaft,
the stator having an annular stator hub arranged at a radially inner portion thereof, the stator support mechanism having an annular retainer being arranged on the engine side of the stator hub and an annular outer race arranged inside a radially inner periphery of the stator hub, a radially outer portion of the retainer being in contact with the stator hub in an axial direction.

11. The torque converter according to claim 10, wherein the stator hub includes an annular portion that annularly projects toward the engine and engages with the retainer in a radial direction.

12. The torque converter according to claim 11, wherein the retainer is fitted in a radially inner periphery of the annular portion to be non-rotatable relative to the stator hub.

13. A torque converter arranged around a fixed shaft and transmitting torque from an engine to an output shaft extending toward a transmission by fluid, comprising:
a front cover being arranged on an engine side and configured to transmit torque from the engine;
an impeller being arranged on a transmission side of the front cover to form a fluid chamber together with the front cover and having a plurality of blades therein;
a turbine being arranged on the engine side of the impeller in the fluid chamber to output the torque to the output shaft;
a stator being arranged between radially inner portions of the impeller and the turbine to regulate fluid flow from the turbine to the impeller; and
a stator support mechanism supporting the stator relative to the fixed shaft,
the stator having an annular stator hub arranged at a radially inner portion thereof.
the stator hub having
a cylindrical portion, the stator being fixed to the cylindrical portion, and the cylindrical cylindrically extending in an axial direction, and
a disc portion extending from the cylindrical portion radially inward, and
the stator hub being configured to receive an axial load supported by axial ends of the cylindrical portion.

14. The torque converter according to claim 13, wherein the stator support mechanism includes an annular second thrust bearing that is arranged on the engine side of the stator hub and a retainer arranged between the stator hub and the second thrust bearing in an axial direction.

15. The torque converter according to claim 14, wherein the retainer includes an annular projecting portion that annularly projects toward the engine and engages with the second thrust bearing in a radial direction.

16. The torque converter according to claim 15, wherein the second thrust bearing is fitted in a radially inner periphery of the annular projecting portion.

17. The torque converter according to claim 16, wherein the stator hub includes an annular portion that annularly projects toward the engine and engages with the retainer in a radial direction.

18. The torque converter according to claim 17, wherein the retainer is fitted in an internal periphery side of the annular portion to be unrotatable relative to the stator hub.

19. The torque converter according to claim 6, wherein the retainer includes an annular projecting portion that annularly projects toward the engine and engages with the second thrust bearing in a radial direction.

20. The torque converter according to claim 13, wherein the stator hub includes an annular portion that annularly projects toward the engine and engages with the retainer in a radial direction.
